(19) United States
(12) Patent Application Publication
(10) Pub. No.: US 2026/0073035 A1
(43) Pub. Date: Mar. 12, 2026

(54) ENHANCED ACCESSIBILITY IN TWO-FACTOR AUTHENTICATION

(71) Applicant: T-MOBILE INNOVATIONS LLC, Overland Park, KS (US)

(72) Inventors: Anbalagan Elumalai, Issaquah, WA (US); Margot Beth Aeschliman, Enumclaw, WA (US); Srikanth Bionpally, Sammamish, WA (US)

(21) Appl. No.: 18/826,779

(22) Filed: Sep. 6, 2024

(51) Int. Cl. G06F 21/40; G06F 21/36

(52) U.S. Cl. CPC G06F 21/40; G06F 21/36; G06F 2221/2133

(57) ABSTRACT

Embodiments of the present disclosure are directed to systems and methods for enhancing accessibility in Two-Factor Authentication (2FA). An alternative 2FA solution allows for users to choose from different methods during authentication. For example, users may opt for a voice call where they receive audio instructions that can be responded to via a device keypad. Alternatively or additionally, users may be provided with a link to a touch-based CAPTCHA. These approaches, and aspects thereof, helps ensure that all users, including those with visual impairments or other disabilities, can securely and easily complete the 2FA process, enhancing accessibility and inclusivity while maintaining robust security.

### SUMMARY

The present disclosure is directed, in part, to verifying a user of an application on a user equipment (UE) in a communications network, substantially as shown and/or described in connection with at least one of the figures, and as set forth more completely in the claims.

According to various aspects of the technology, security checkpoints such as Two-Factor Authentication, (2FA) are security processes that require users to verify their identity using additional distinct forms of authentication. A common F2A method includes Completely Automated Public Turing test to tell Computers and Humans Apart (CAPTCHA), which may include challenges that determine whether the user is human, often by requiring them to identify images. They are generally used as a first step to prevent automated bots from accessing the network or service.

Typical CAPTCHAs, while effective in distinguishing humans from bots, present significant accessibility challenges for blind or disabled users, particularly those with visual impairments. Traditional visual CAPTCHAs, which require users to identify distorted text or select images, are often inaccessible to screen readers and can be nearly impossible for individuals with vision loss to complete. This exclusion can severely impact the ability of over a billion people worldwide living with vision loss to securely access online services, creating barriers that extend beyond mere inconvenience to affect their participation in both personal and professional environments. For people with disabilities, over 50% have cited accessibility as a critical factor in choosing online services, reflecting how inaccessible CAPTCHAs can drive them away from certain platforms. This is especially significant given that people with disabilities hold an estimated $8 trillion in disposable income annually. When online services fail to accommodate these users, they not only miss out on a substantial market but also risk perpetuating inequities by limiting access to essential services. Therefore, it is important for companies and telecom providers to consider more inclusive security measures to help ensure that all users, regardless of their abilities, can securely and easily access their services.

To address the accessibility challenges posed by traditional CAPTCHAs, alternative CAPTCHA services may be offered during 2FA. This approach empowers users to select a method that best suits their needs, enhancing inclusivity. For example, instead of relying on visual CAPTCHAs, a user could opt to receive a phone call where they are provided with audio instructions, such as being asked to enter a specific number or solve a simple math equation. The user would then input their answer via the keypad on their device, ensuring that the authentication process remains both secure and accessible. As another example, users could be sent a link to a website where they could complete a touch-based CAPTCHA, such as tracing a pattern or tapping on specific objects, which is useful for those with visual impairments who find traditional CAPTCHAs difficult. Accordingly, the present solution involves systems and methods for verifying a user of an application on a user equipment in order to provide increased accessibility for blind or disabled users.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure may be employed;

FIG. 3 illustrates an example flow diagram in which implementations of the present disclosure may be employed;

FIG. 4 illustrates another example flow diagram in which implementations of the present disclosure may be employed;

FIG. 5 illustrates a flow chart of an exemplary method for verifying a user of an application on a user equipment (UE) in a communications network in which implementations of the present disclosure may be employed;

FIG. 6 illustrates a flow chart of another exemplary method for verifying a user of an application on a user equipment (UE) in a communications network in which implementations of the present disclosure may be employed; and

FIG. 7 illustrates a flow chart of another exemplary method for verifying a user of an application on a user equipment (UE) in a communications network in which implementations of the present disclosure may be employed.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022).

The example aspects and embodiments described in the present disclosure are provided within the context of a wireless telecommunication network for illustrative purposes. However, it should be understood that the principles and techniques discussed herein are not limited to wireless networks alone. The concepts and methodologies can be equally applied to other types of communication networks, including but not limited to wired, satellite, and optical networks. These alternative networks are capable of supporting the functionalities and applications described, and their use falls within the scope of the present disclosure.

As used herein, an “Unstructured Supplementary Service Data (USSD) gateway” may refer to a component in a communications network that facilitates real-time, session-based communication between a UE and other components (e.g., an application server). The USSD gateway may handle the routing and processing of USSD requests, enabling interactive services such as balance inquiries, mobile banking, and menu-driven applications. A “USSD session” may refer to a temporary, interactive communication session (e.g., non-voice session) established between a mobile device and another component (e.g., an application server) via the USSD gateway. A USSD session may be initiated by an indicator such as a USSD code, which may act as a request for the USSD session. After a session is established, communication may comprise USSD messages (e.g., short text-based communications), which may be sent and received in real-time.

As used herein, an “application server” may refer to a software and/or hardware framework that provides the environment for running applications, facilitating the processing of business logic and data exchange between users and back end systems. Depending on the deployment scenario, an application server can either be maintained and operated by a client outside the network or within the network as part of the infrastructure managed by the network operator. When located outside the network, the application server may typically be owned by a client of the network operator, such as a bank or utility company, and handles specialized functions like processing transactions, customer interactions, or service requests. In such a scenario, the application server communicates with the network (e.g., a USSD gateway) via secure connections (e.g., an API). Conversely, when the application server is within the network, it may be managed by the network operator, providing essential services like authentication, billing, or content delivery directly integrated into the network infrastructure.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, Two-Factor Authentication (2FA) is a security measure designed to enhance the protection of user accounts by requiring two distinct forms of verification before access is granted. This process helps ensure that even if one form of authentication, such as a password, is comprised, the additional layer makes it harder for unauthorized users to gain access. Typically, 2FA involves something the user knows (e.g., a password or PIN) and something the user possesses (e.g., a mobile device or a hardware token). After entering their password, the user is prompted to complete a second step, which might involve entering a one-time password (OTP), which acts as an additional time-sensitive security layer. The user must enter this code correctly to verify their identity and access the system or service.

While 2FA may be a powerful tool for enhancing security, conventional 2FA methods can present significant accessibility challenges, particularly for those individuals with disabilities. Traditional 2FA often relies on visual or text-based methods, which can be difficult or impossible for users with visual impairments to navigate. Even for people without disabilities, CAPTCHA challenges that sometimes accompany 2FA are frequently difficult, which further illustrates the complexity of the user verification process for those who rely on assistive technologies. These barriers can prevent users from securely accessing vital services, leading to frustration and exclusion. Given that over a billion people worldwide live with vision loss and many more experience other forms of disability, it is beneficial for 2FA systems to offer more accessible alternatives.

To address the accessibility challenges associated with conventional 2FA, one solution allows users to opt for an alternative CAPTCHA by entering a USSD code at the 2FA prompt on an application. This code may act as a trigger, initiating a USSD session between the user's UE and an application server via a USSD gateway. Once the session is established, the application server may generate an alternative 2FA (e.g., an alternative CAPTCHA), such as a touch-based CAPTCHA, and send instructions back to the UE in the form of a USSD message. These instructions might include a link to a website where the CAPTCHA can be completed or guidance on opening a specific mobile application that facilitates the CAPTCHA. By providing a touch-based or more accessible CAPTCHA option, this approach ensures that users with disabilities can securely complete the 2FA process without being hindered by inaccessible traditional CAPTCHA methods.

Another solution involves users initiating an alternative CAPTCHA by entering their contact number at the 2FA stage on an application, which similarly acts as a trigger for initiating one or more sessions. For example, a non-voice session may be initiated between the UE and an application server via a USSD gateway, followed by an establishment of a voice call with the UE. During the voice call, the user may be given an alphanumeric string, communicated via audio. The user then enters this string as a USSD message and submits it back to the application server through the USSD gateway to complete the verification process. These methods, and aspects thereof, help to provide a secure and accessible way for users, particularly those with visual impairments, to complete the 2FA process by leveraging audio cues and USSD-based input, ensuring a more inclusive authentication experience.

Accordingly, a first aspect of the present disclosure is directed to a system for verifying a user of an application on a user equipment (UE) in a communications network. The system includes a network storage device and a network device comprising one or more processors. The system further includes a non-transitory computer-readable media configured to receive a request for an alternative Completely Automated Public Turing test to tell Computers and Humans Apart (CAPTCHA) service from the UE. The computer-readable media is further configured to initiate an Unstructured Supplementary Service Data (USSD) session with the UE. The computer-readable media is further configured to forward the request to an application server. The computer-readable media is further configured to receive, from the application server, instructions for the user to perform the alternative CAPTCHA. The computer-readable media is further configured to deliver the instructions to the UE via the USSD session.

A second aspect of the present disclosure is directed to a non-transitory computer-readable media that, when executed, cause a user equipment comprising one or more processors to perform operations for verifying a user of an application on a user equipment (UE) in a communications network. For example, the computer-readable media is configured to initiate a non-voice session with the UE in response to the UE communicating an indicator to an application server for an alternative Two-Factor Authentication (2FA). The computer-readable media is further configured to establish a voice call with the UE, the voice call comprising an alphanumeric string. The computer-readable media is further configured to receive, via the non-voice session, the alphanumeric string. The computer-readable media is further configured to communicate the alphanumeric string to the application server.

A third aspect of the present disclosure is directed to a method for verifying a user of an application on a user equipment (UE) in a communications network. The method includes receiving a request for an alternative Completely Automated Public Turing test to tell Computers and Humans Apart (CAPTCHA) service from the UE. The method further includes initiating an Unstructured Supplementary Service Data (USSD) session with the UE. The method further includes receiving, from an application server, instructions for the user to perform the alternative CAPTCHA. The method further includes delivering the instructions to the UE via the USSD session.

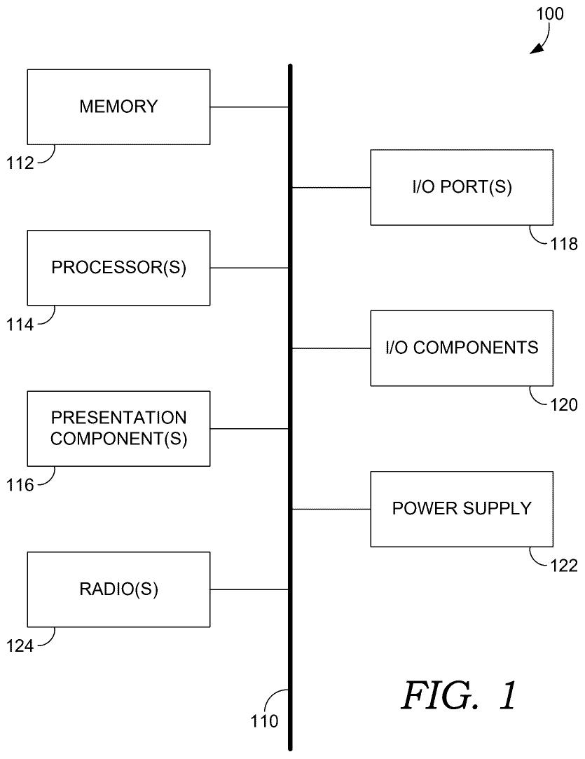

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device, The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitted to communicate with a wireless telecommunications network. It is expressly contemplated that a computing device 100 with more than one radio 120 could facilitate communication with the wireless network via both the first transmitter and additional transmitters (e.g. a second transmitter). Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, VoLTE, or other VoIP communications. As can be appreciated, in various embodiments, radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

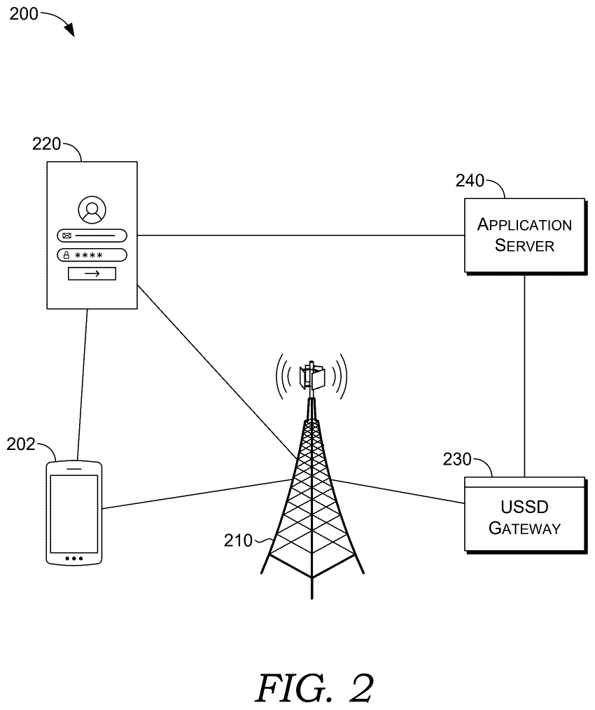

Referring now to FIG. 2, an exemplary network environment is illustrated in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment be interpreted as having any dependency or requirement relating to any one or combination of components illustrated.

Network environment 200 represents a high level and simplified view of relevant portions of a modern wireless telecommunication network. At a high level, the network environment 200 may generally be said to comprise one or more UEs, such as UE 202 (e.g., utilizing an application 220 on the UE 202), one or more base stations, such as a base station 210, a USSD Gateway 230, and an application server 240, though in some implementations, it may not be necessary for certain features to be present. The network environment may include a number of routers, switches, and the like. The network environment 200 is generally configured for wirelessly connecting the UE 202 to data or services that may be accessible on the application server 240 or other functions, nodes, or servers not pictured in FIG. 2 so as to not obscure the focus on the present disclosure.

The UE 202 is illustrated generally, and may take any number of forms, including a tablet, phone, or wearable device, or any other device discussed with respect to FIG. 1 and may have any one or more components or features of the computing device 100 of FIG. 1. In some aspects, the UE 202 may not be a conventional telecommunications devices (i.e., a device that is capable of placing and receiving voice calls), but may instead take the form of devices that only utilizes wireless network resources in order to transmit or receive data; such devices may include IoT devices (e.g., smart appliances, thermostats, locks, smart speakers, lighting devices, smart receptacles, and the like).

The base station 210 may provide a network access location where the UE may potentially connect to (also referred to as ‘camping on,’ ‘attaching,’ in the industry). Though network environment 200 is illustrated with only the base station 210, one skilled in the art will appreciate that more or fewer base stations may be present in any particular network environment. The first base station 210 is configured to wirelessly communicate with UEs, such as the UE 202. In aspects, the base station 210 may communicate with the UE 202 using any wireless telecommunication protocol desired by a network operator, including but not limited to 3G, 4G, 5G, 6G, 802.11x and the like.

The application 220 may comprise any application on the UE 202 where a user encounters 2FA. For example, the application 220 may comprise a mobile or web-based service that required enhanced security to protect sensitive information and ensure secure access. These could include mobile banking apps, where users need to verify their identity before viewing account balances or performing transactions; email services that require 2FA to safeguard personal or business communications; and social media platforms that use 2FA to prevent unauthorized access to user accounts. When a user accesses the application 250 on the UE 202, they may be prompted with a traditional 2FA after entering their initial credentials; however, when the user has visual impairments or other disabilities, the user may be provided with one or more alternatives for enhanced accessibility.

In some aspects, the user can bypass the traditional 2FA by requesting an alternative CAPTCHA. Such a request may comprise entering a pre-configured USSD code (e.g., *123#) into the application 250. The USSD code may act as a trigger to initiate the alternative CAPTCHA process. In some aspects, the user may communicate an indicator, such as a unique personal identifier or their phone number, in response to the initial 2FA prompt. Upon receiving this indicator, the network may verify that the identifier matches the user's account information stored in the application 250. Once verified, a voice call may be initiated with the UE 202. These non-limiting examples show how such an incorporation of the application 250 into the network environment 200 might allow users to initiate and/or request alternative 2FA processes so that their accessibility may be enhanced.

The USSD Gateway 230 may comprise a network device within the network environment 200 that facilitates real-time, session-based communication between the UE 202 and the application server 240. As part of the network infrastructure, the USSD Gateway 230 may be responsible for managing and routing USSD requests, which may be short, text-based messages used for interactive services. When the user initiates the request, the USSD Gateway 230 may initiate a USSD session with the UE 202. This session may allow for a continuous, interactive exchange of messages between the UE 202 and the application server 240, helping enable real-time processing of user inputs and responses. In this way, the USSD Gateway 230 may serve as a connection point, translating the user's actions into requests that the application server 240 can understand and respond to, and then relaying the application server's 240 instructions back to the UE 202. Such a seamless interaction helps ensure that users can engage with services, such as alternative 2FA methods, efficiently and securely, and may be able to do so directly through their mobile devices without requiring an internet connection.

The application server 240 may be either within the communications network or external to it, depending on the deployment needs. The application server 240 is connected to the USSD Gateway 230. In some aspects, the USSD Gateway 230 and the application server 240 may interface through a User Service Data (USD) API, which allows the USSD Gateway 230 to communicate user requests and receive responses from the application server 240 in a structured and standardized manner. Additionally, an Account Information and Recharge (AIR) interface may be used where the USSD Gateway 230 may be able to access and manage user-specific data that might be part of the 2FA process. In either case, the USSD Gateway 230 may act as an intermediary, translating the user's USSD request into an API call or AIR request that the application server 240 can process. Through this connection, the application server 240 may receive requests initiated by the user, such as a request for an alternative CATPCHA during the 2FA process. The application server 240 may be responsible for generating these alternative CAPTCHAs, which could include touch-based challenges or other accessible options. Once generated, the application server 240 may send the instructions back to the UE 202 via the USSD gateway 230, allowing the user to complete the authentication process in a manner suited to their needs. Such a setup may help ensure that the application server 240 effectively manages and processes user interactions, providing secure and accessible 2FA solutions.

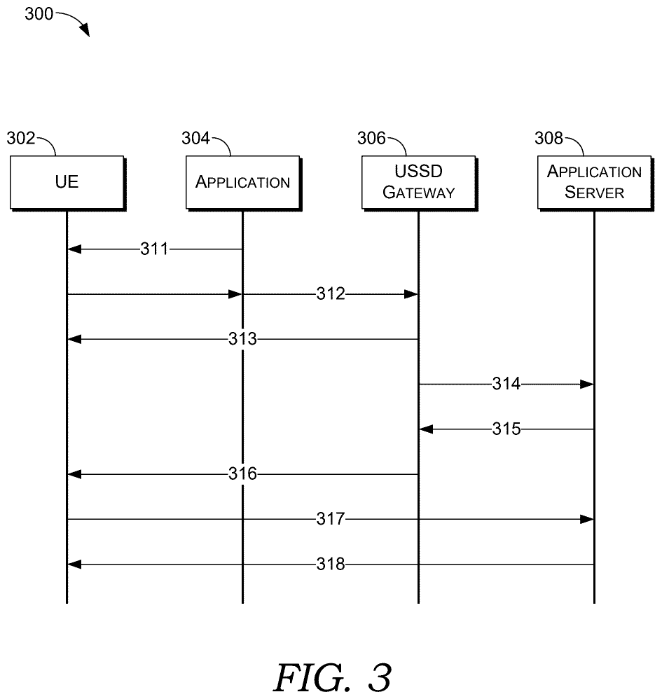

Turning now to FIG. 3, a flow diagram is illustrated in accordance with one or more aspects of the present disclosure. A flow diagram 300 may be said to exist between one or more components discussed in greater detail herein and is not meant to exhaustively show every interaction that would be necessary to practice the invention, so as not to obscure the present disclosure, but is instead meant to illustrate one or more potential interactions between components. The flow diagram 300 may be relevantly said to include a UE 302, an application 304, a USSD Gateway 306, and an application server 308. In some aspects, the UE 302 may be the same or similar to the UE 202, the application 304 may be the same or similar to the application 220, the USSD Gateway 306 may be the same or similar to the USSD Gateway 230, and the application server 308 may be the same or similar to the application server 240 discussed above.

FIG. 3 illustrates an example method for verifying a user of an application on a UE in a communications network. At a first step 311, the application 304 may initiate a 2FA prompt after the user has successfully entered their initial login credentials. The application 304 on the UE 302 may display a prompt (e.g., a notification or pop-up) informing the user that they need to complete a secondary authentication step. This 2FA prompt may include an ability for the user to request an alternative CAPTCHA by entering a USSD code, or providing input, that triggers the alternative CAPTCHA service. At a second step 312, the user, upon receiving the 2FA prompt on the UE 302, opts to user the alternative CAPTCHA service by entering a specific (e.g., pre-defined) USSD code at the application 304, which may be entered directly into the input field of the 2FA prompt. Upon receiving the USSD code, the UE 302 may transmit it as a USSD message, where it will be routed to the USSD Gateway 306. The USSD Gateway 306 may recognize this as a trigger for the alternative CAPTCHA service, which may prompt the USSD Gateway 306 to initiate further steps.

At a third step 313, after the USSD Gateway 306 receives the USSD code entered by the user, it may begin by initiating a USSD session with the UE 302. The USSD Gateway 306, having recognized the code as a trigger for the alternative CAPTCHA, sends a response back to the UE 302, establishing a real-time, interactive communication session. This session allows continuous two-way communication between the user and the application server 308 throughout the authentication process. Once the USSD session is established, the USSD Gateway 306 may send instructions, prompts, or other necessary information to the user in the form of USSD messages. In this context, the USSD session may act as the channel through which the alternative CAPTCHA service may be provided, helping ensure that the user can interact with the system in real-time without needing an active internet connection. The USSD session may remain open until the user completes the necessary steps to verify their identity, at which point the session may be terminated. At a fourth step 314, the USSD Gateway 306 proceeds to establish a session with the application server 308. The USSD Gateway 306 forwards the user's request for the alternative CAPTCHA service, which was initially received as a USSD code, to the application server 308 responsible for handling the 2FA process. To do this, the USSD Gateway 306 may first interpret the user's USSD request, and then format it into a suitable request, such as a REST API call or an AIR interface message, depending on the communication protocols established. The USSD Gateway 306 may include key information in the forwarded request, such as the user's mobile number (e.g., MSISDN) and any other relevant session data, helping ensure that the application server 308 has the details to process the request accurately. This session also helps ensure that the application server 308 can communicate back to the USSD Gateway 306.

At a fifth step 315, the application server 308, upon receiving the request forwarded by the USSD Gateway 306, may begin processing the request to generate an alternative CAPTCHA tailored to the user's needs. The application server 308 may generate the appropriate alternative CAPTCHA, which could be a touch-based challenge, a simple numeric puzzle, or another form of accessible verification method. The application server 308 may also prepare instructions on how the user can complete the alternative CAPTCHA. These instructions might include a direct link to a mobile-friendly website where the CAPTCHA can be performed or steps to open a specific mobile application designed to facilitate the CAPTCHA process. The application server 308 may then package this information into a response message and send it back to the USSD Gateway 306. At a sixth step 316, the USSD Gateway 306 receives the response from the application server 308, which includes the instructions on how to perform the alternative CAPTCHA. Upon receiving the instructions, the USSD Gateway 306 formats it into a USSD message suitable for delivery to the UE 302. The instructions are then sent to the UE 302 as the USSD message through the active USSD session that was previously established. The instructions (e.g., the USSD message) may appear on the UE 302 as a simple text prompt. In some aspects, since the USSD operates independently of data services, the user can receive an interact with these instructions even without an internet connection. This may help ensure that the 2FA process remains accessible and efficient, allowing the user to proceed with the alternative CAPTCHA using the guidance provided in the instructions.

At a seventh step 317, the user, having received the instructions via the USSD message from the USSD Gateway 306, proceeds to perform the alternative CAPTCHA as directed. Depending on the instructions provided, this could involve navigating to a specified website, opening a mobile application, and/or directly entering a response through the USSD session itself. For example, if the CAPTCHA requires the user to solve a numeric puzzle or enter a specific code, the user would input their answer using their device's keypad. The application server 308 may capture the user's input while performing the alternative CAPTCHA and compare the user's response against the correct answer or expected input for the alternative CAPTCHA. If the user's input matches the expected criteria, the application server 308 verifies the response, confirming that the user has successfully passed the alternative CAPTCHA challenge. At an eighth step, the application server 308 communicates this success back to the USSD Gateway 306, which then initiates the closure of the USSD session between the UE 302 and the network. Once the USSD session is closed, the system sends a confirmation message to the user, typically via SMS. The message might simply state that the user's identity has been verified and that they can now access the application or service, providing reassurance that the alternative CAPTCHA was processed correctly.

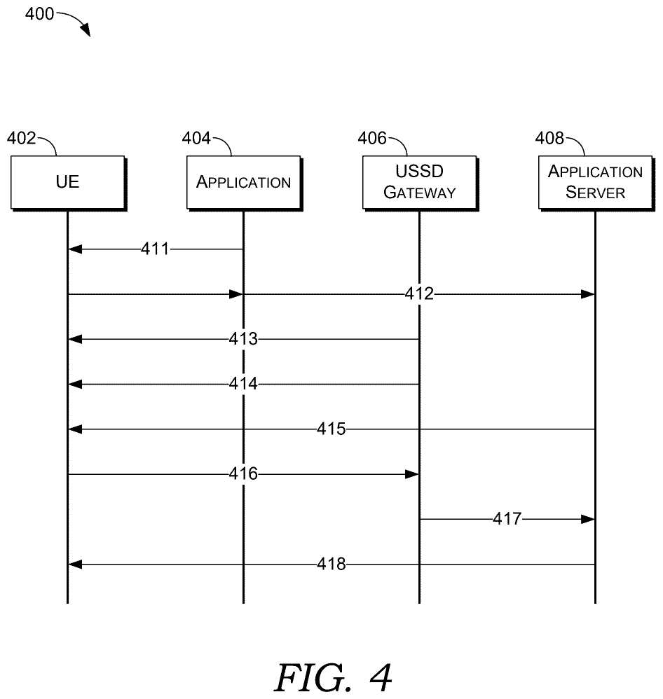

Turning now to FIG. 4, a flow diagram is illustrated in accordance with one or more aspects of the present disclosure. A flow diagram 400 may be said to exist between one or more components discussed in greater detail herein and is not meant to exhaustively show every interaction that would be necessary to practice the invention, so as not to obscure the present disclosure, but is instead meant to illustrate one or more potential interactions between components. The flow diagram 400 may be relevantly said to include a UE 402, an application 404, a USSD Gateway 406, and an application server 408. In some aspects, the UE 402 may be the same or similar to the UE 202, the application 404 may be the same or similar to the application 220, the USSD Gateway 406 may be the same or similar to the USSD Gateway 230, and the application server 408 may be the same or similar to the application server 240 discussed above.

FIG. 4 illustrates an example method for verifying a user of an application on a UE in a communications network. At a first step 411, the application 404 on the user's UE 402 initiates a 2FA prompt after the user has successfully entered their initial login credentials. In some aspects, the application 404 provides the user with an option to request an alternative 2FA service by entering their contact number (e.g., phone number), into the provided field. For example, when the user is presented with the 2FA prompt, they may see an option to enter their contact number as an alternative to traditional CAPTCHA methods. At a second step 412, the user opts for the alternative 2FA method by entering their contact number within the 2FA prompt on the UE 402. Once the user submits this information, this information is communicated to the application server 408. In some cases, the network may perform a verification check to help ensure that the contact number provided matches the number associated with the user's account on the application 404. This may involve cross-referencing the entered contact number with the records stored in the application's 404 database. The application server 408, now in possession of the indicator for the alternative 2FA (e.g., the contact number), further initiates the process for the alternative 2FA.

At a third step 413, following the verification of the user's contact number and the triggering of the alternative 2FA process, the USSD Gateway 406 may initiate a non-voice session with the user's UE 402. In some cases, the USSD Gateway 406 may initiate a USSD session. In other cases, an SMS session may be initiated. Such a non-voice session helps prepare the communication pathway between the UE 402 and the application server 408 because it establishes a secure and continuous link for the upcoming interactions. The USSD Gateway 406 may send a session start message to the UE 402, which may be automatically accepted by the UE 402. At a fourth step 414, the USSD Gateway 406 may proceed to facilitate the establish of a voice call with the UE 402. For example, the USSD Gateway 406 may communicate with the network's call management system to trigger the voice call, using the contact number that was provided and verified in the earlier steps. Accordingly, the USSD Gateway 406 may help ensure that the voice call is initiated correctly and directed to the user's UE 402. Once the call is initiated, the UE 402 may receive an incoming call from the application server 408 or a designated system within the network.

At a fifth step 415, the user may answer the incoming voice call at the UE 402 initiated as part of the alternative 2FA process. Upon answering, the user may be greeted with an automated message or a voice prompt generated by the application server 408. This prompt may provide the user with an alphanumeric string, which could take various forms depending on the nature of the challenge. For example, the alphanumeric string might be a straightforward sequence of numbers and letters that the user needs to enter. Alternatively, it could include a short math question or simple instructions. At a sixth step 416, the user responds by entering the alphanumeric string into the UE's 402 keypad. For example, instead of speaking or using the voice call directly, the user may input the alphanumeric string through the non-voice session. In cases where the non-voice session is a USSD session, the user may input the alphanumeric string as a USSD message and communicate it back to the USSD Gateway 406. The USSD Gateway 406 captures the entered alphanumeric string and prepares to forward this information to the application server 408 for verification.

At a seventh step 417, the USSD Gateway 406, having received the alphanumeric string entered by the user (e.g., as a USSD message), forwards this information to the application server 408 for verification. The USSD Gateway 406 may act as a secure conduit between the user's UE 402 and the application server 408, helping ensure that the transmitted data is delivered accurately and promptly. Upon receiving the alphanumeric string, the application server 408 may compare the string entered by the user against the expected correct value that was originally provided during the voice prompt. If the alphanumeric string is verified as correct, the application server 408 confirms the successful completion of the alternative 2FA, verifying the user's identity and authoring access to the application 404. At an eighth step 418, once the application server 408 successfully verifies the alphanumeric string entered by the user, the system confirms that the 2FA process has been completed successfully. Upon receiving this confirmation, the USSD Gateway 406 proceeds to close the non-voice session, which signifies the end of the 2FA process. To inform the user of the successful authentication, a confirming is then sent to the UE 402.

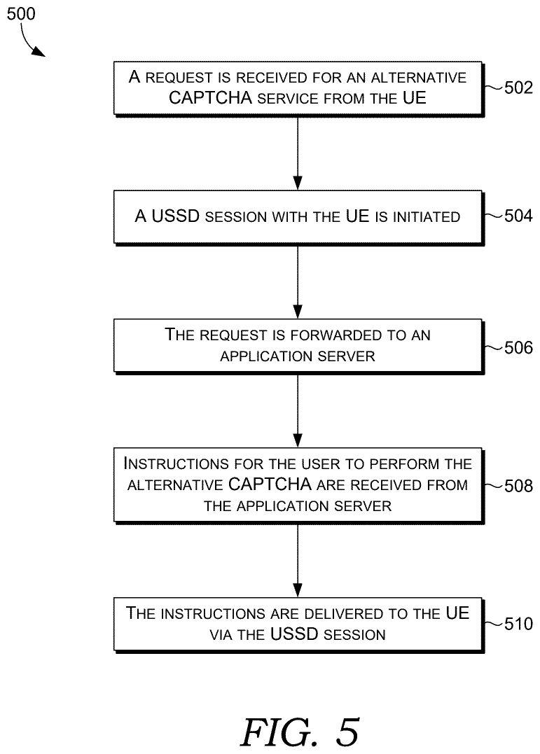

Turning now to FIG. 5, a flow chart is provided that illustrates one or more aspects of the present disclosure relating to a method 500 for verifying a user of an application on a user equipment (UE) in a communications network. For example, at a first step 502, a request is received for an alternative CAPTCHA service from the UE. At a second step 504, a USSD session with the UE is initiated. At a third step 506, the request is forwarded to an application server. At a fourth step 508, instructions for the user to perform the alternative CAPTCHA are received from the application server. At a fifth step 510, the instructions are delivered to the UE via the USSD session.

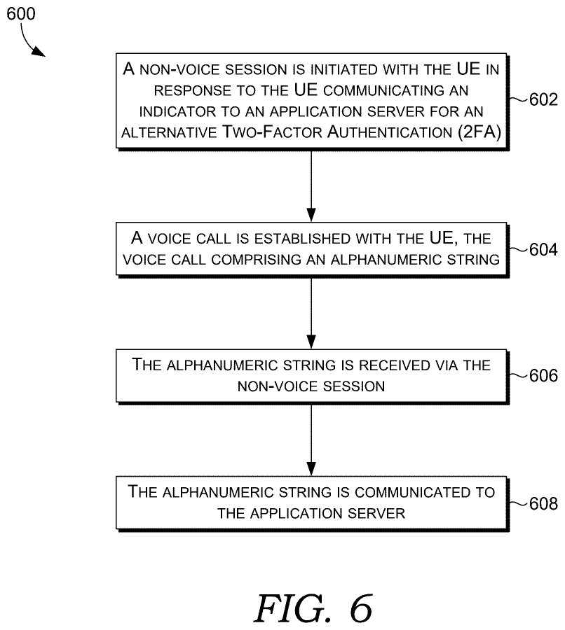

Turning now to FIG. 6, a flow chart is provided that illustrates one or more aspects of the present disclosure relating to a method 600 for verifying a user of an application on a user equipment (UE) in a communications network. For example, at a first step 602, a non-voice session is initiated with the UE in response to the UE communicating an indicator to an application server for an alternative Two-Factor Authentication (2FA). At a second step 604, a voice call is established with the UE, the voice call comprising an alphanumeric string. At a third step 606, the alphanumeric string is received via the non-voice session. At a fourth step 608, the alphanumeric string is communicated to the application server.

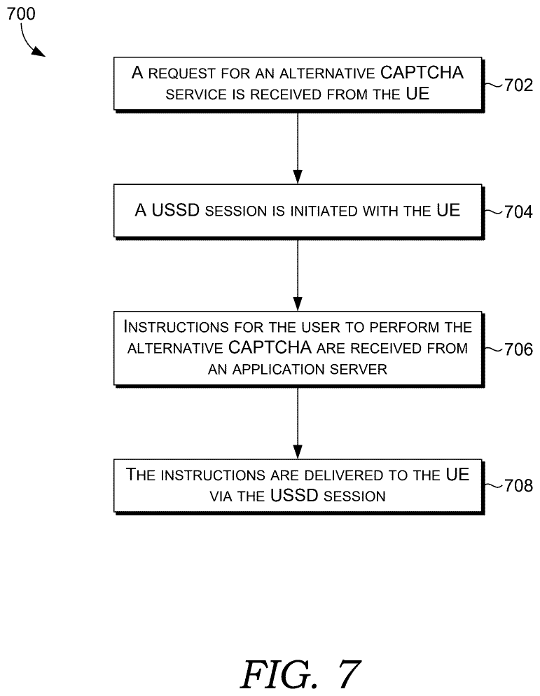

Turning now to FIG. 7, a flow chart is provided that illustrates one or more aspects of the present disclosure relating to a method 700 for verifying a user of an application on a user equipment (UE) in a communications network. For example, at a first step 702, a request for an alternative CAPTCHA service is received from the UE. At a second step 704, a USSD session is initiated with the UE. At a third step 706, instructions for the user to perform the alternative CAPTCHA are received from an application server. At a fourth step 708, the instructions are delivered to the UE via the USSD session.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for verifying a user of an application on a user equipment (UE) in a communications network, the system comprising:
a network device comprising one or more processors; and
a non-transitory computer-readable media comprising executable instructions that, when executed, causes the network device to perform operations in a communication network, comprising:
receiving a request for an alternative Completely Automated Public Turing test to tell Computers and Humans Apart (CAPTCHA) service from the UE;
initiating an Unstructured Supplementary Service Data (USSD) session with the UE;
forwarding the request to an application server;
receiving, from the application server, instructions for the user to perform the alternative CAPTCHA; and
delivering the instructions to the UE via the USSD session.

2. The system of claim 1, wherein the instructions comprise one or more of opening a mobile application or a link to access a webpage where the alternative CAPTCHA can be performed by the user.

3. The system of claim 2, wherein the alternative CAPTCHA is generated by the application server.

4. The system of claim 1, wherein an input of the user performing the alternative CAPTCHA is verified at the application server.

5. The system of claim 1, wherein the alternative CAPTCHA comprises a touch-based CAPTCHA including one or more of an image recognition and selection challenge, a slide puzzle challenge, a touch and hold challenge, and a follow a path challenge.

6. The system of claim 1, wherein the instructions are delivered to the UE via a USSD message.

7. The system of claim 1, where the network device is a USSD gateway.

8. The system of claim 7, wherein the USSD gateway interfaces with the application server through a User Service Data Application Programming Interface (USD API) and/or an Account Information and Recharge (AIR) interface.

9. The system of claim 1, wherein a USSD code is pre-defined to initiate the alternative CAPTCHA service, and wherein the request for the alternative CAPTCHA service is received based on the USSD code being entered during a verification process of the user on the application.

10. A non-transitory computer-readable media comprising executable instructions that, when executed, causes a network device comprising one or more processors to perform operations for verifying a user of an application on a user equipment (UE) in a communications network, the operations comprising:
initiating a non-voice session with the UE in response to the UE communicating an indicator to an application server for an alternative Two-Factor Authentication (2FA);
establishing a voice call with the UE, the voice call comprising an alphanumeric string;
receiving, via the non-voice session, the alphanumeric string; and
communicating the alphanumeric string to the application server.

11. The computer-readable media of claim 10, wherein the non-voice session is an Unstructured Supplementary Service Data (USSD) session.

12. The computer-readable media of claim 10, wherein the non-voice session is a Short Message System (SMS) session.

13. The computer-readable media of claim 10 further comprising initiating the non-voice session with the application server, and wherein the alphanumeric string is communicated to the application server via the non-voice session with the application server.

14. The computer-readable media of claim 10, where the network device is a USSD gateway.

15. The computer-readable media of claim 14, wherein the USSD gateway interfaces with the application server through a User Service Data Application Programming Interface (USD API) and/or an Account Information and Recharge (AIR) interface.

16. The computer-readable media of claim 10, wherein the UE communicating the indicator comprises the user submitting a contact number in response to a 2FA.

17. A method for verifying a user of an application on a user equipment (UE) in a communications network, the method comprising:
receiving a request for an alternative Completely Automated Public Turing test to tell Computers and Humans Apart (CAPTCHA) service from the UE;
initiating an Unstructured Supplementary Service Data (USSD) session with the UE;
receiving, from an application server, instructions for the user to perform the alternative CAPTCHA; and
delivering the instructions to the UE via the USSD session.

18. The method of claim 17, wherein the instructions comprise one or more of opening a mobile application or a link to access a webpage where the alternative CAPTCHA can be performed by the user.

19. The method of claim 17, wherein the instructions are delivered to the UE via a USSD message.

20. The method of claim 17, wherein a USSD code is pre-defined to initiate the alternative CAPTCHA service, and wherein the request for the alternative CAPTCHA service is received based on the USSD code being entered during a verification process of the user on the application.
